(19) United States
(12) Patent Application Publication
(10) Pub. No.: US 2004/0208244 A1
(43) Pub. Date: Oct. 21, 2004

(54) Optimal video decoder based on MPEG-type standards

(76) Inventors: Michel Barlaud, Valbonne (FR); Marc Antonini, Nice (FR); Joel Jung, Antibes (FR)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/749,784

(22) Filed: Dec. 30, 2003

Related U.S. Application Data
(63) Continuation of application No. 09/406,673, filed on Sep. 27, 1999, now abandoned.

(30) Foreign Application Priority Data
Jun. 11, 1999 (FR) FR 99/007443

(51) Int. Cl. H04N 7/12

(52) U.S. Cl. 375/240.12; 375/240.01; 375/240.24

(57) ABSTRACT

The invention concerns a process for decompression of compressed animated images with a method including treatment of images in blocks and containing a digital data recomposition phase defining predefined forms, a phase modeling the movement of these forms using a process of prediction, interpolation and temporal compensation, an image composition phase from reconstructed elements of JPEG or MPEG type motion, characterized by the fact that the form recomposition phase includes a process for separating fixed forms from mobile forms, a process for recording digital data corresponding to the fixed forms treated by a filter not separable from the processes implemented in the recomposition phase in a first specific memory unit and digital data corresponding to mobile forms in a second specific memory unit.

### CLAIM OF PRIORITY

This application claims priority under 35 U.S.C. § 119(a) to French patent application 99 07443, filed Jun. 11, 1999.

### TECHNICAL FIELD OF THE INVENTION

The invention concerns the display of animated images, in particular decompression of digital data which incorporate these images using optimized methods.

### BACKGROUND OF THE INVENTION

With the appearance of the most recent digital technologies, and the ever-increasing need for speed and storage space, compression cannot be avoided for mainstream applications. Examples include digital cameras which code images in JPEG, digital camcorders which compress DV format sequences, an M-JPEG derivative, or digital television and DVD, which have adopted the MPEG-2 compression format, in addition, of course, to the Internet, in which images and sequences are sent in compressed form.

In certain cases, the user requires very high quality (photo, camcorder), implying very low rates of compression. In other cases, excessive transfer time prevents acceptable quality. It is, therefore, necessary to improve sequence decoding to permit either better quality at an equivalent rate, or a weaker rate with equal or superior quality.

Different animated image compression standards have been proposed, but only the MPEG standard has really taken hold. This standard for the compression and decompression of animated images leads to the appearance of block effects.

For example, European patent EP539833 concerns a process designed to produce a compressed video data representation which can be displayed on a video screen after decompression according to a number of hierarchical scales of image and/or quality resolution, including phases which consist of:

providing video image element data signals indicating block units in space or macro-blocks, which associate the information concerning the compressed image data with a group of coding attributes, including coding decisions, movement compensation vectors, and quantification parameters, and

producing for each of these macro-blocks a macro block which is placed on the corresponding scale for each scale of this multiplicity so that the same coding attributes are shared by these scaled macro-blocks.

Methods enabling decompression errors to be corrected have been proposed by previous researchers. These methods primarily concern techniques used after the process of image decompression itself and slow down this compression. These methods do not take the quantifier into account and do not permit the binary frame to be retained after recompression, which has the effect of degrading image quality with each compression. A goal of the invention is to propose a process for improving image quality during decompression.

### SUMMARY OF THE INVENTION

The invention concerns a process for decompression of compressed animated images with a method including treatment of images in blocks and containing a digital data recomposition phase defining predefined forms, a phase modeling the movement of these forms using a process of prediction, interpolation and temporal compensation, an image composition phase from reconstructed elements of JPEG or MPEG type motion. The form recomposition phase includes a process for separating fixed forms from mobile forms, a process for recording digital data corresponding to the fixed forms treated by a filter which is not separable from the processes implemented in the recomposition phase in a first specific memory unit and digital data corresponding to mobile forms in a second specific memory unit.

Beneficially, the digital filter is irreducible and does not contain dissociable filters. In one variant, the filter eliminates the block effect on the background image. It can regularize the background image. Beneficially, the quantification interval used during compression of the background image is stored and projected on the quantification interval.

In one variant, reconstruction of the elements uses quantification parameters previously defined by the coder during image compression. These parameters are linked to the image photography methods and permit decompression to be adapted based on these methods. This permits taking account of the compression characteristics and improving image decompression. In one variant, the quantification parameters are defined by the transfer function of the methods of acquisition and storage of animated images.

Beneficially, a second digital filter separates and identifies the mobile elements into mobile objects moving in a sequence, in accordance with the evolution of predetermined digital criteria, such as the geometry of mobile objects, movement of mobile objects, or spatial segmentation of mobile objects. Temporal averaging can also take place with compensation for the movement of each identified object. In one variant, the filter eliminates the block effect from objects. According to this process, the objects identified can also be regularized.

Beneficially, the quantification interval serving to compress the animated sequence is stored and is projected on the quantification interval. During display, the mobile objects and averaged representation are superimposed in the fixed image time.

Preferably, the parameters specific to each object identified are stored separately in order to treat each object differently.

The invention also concerns a device for decompression of compressed animated images with a method including image treatment in blocks and a digital data recomposition phase defining predefined forms, a movement modeling stage of these forms using methods for prediction, interpolation and temporal compensation, an image composition phase from reconstructed elements of JPEG or MPEG type motion. It includes methods for separating fixed forms from mobile forms, and methods for recording digital data corresponding to the fixed forms treated by a filter which is not separable from the methods implemented in the recomposition phase in a first specific memory unit, and digital data corresponding to mobile forms in a second specific memory unit.

This device also beneficially includes irreducible digital filtering methods, which cannot be decomposed into a sequence of filters independent of one another.

It includes, preferably, storage methods for the types of images compressed.

One variant of this device includes a detachable medium and can be made with an independent chip or a graphics memory card that can be inserted into a computer. This device can also be inserted without being separated into a computer or into any type of electronic apparatus permitting image display.

This device can also be comprised using an independent software module from the software present in a calculator memory.

The invention consists of a decoding process for reducing both the block effects and defects linked to degradation of the sequence media.

This method treats the problem spatially and temporally, obtaining significant improvement in sequence quality, and is based on two ideas:

simultaneously treating the problems of block suppression and movement segmentation,

integrating the notion of object, in order to permit a different approach for treatment of the background and of each object.

In addition, this method presents the particular characteristic of effectively treating the problem of “drop-out”, independent of the original sequence format: the image blocks lost to acquisition by the camera, or during transmission are perfectly restored; and defects such as abrasions and threads are removed from digital film. In addition, it is possible to integrate the process of accounting for the objective transfer function of the camera, or the projector, into the decoding process to obtain a more precise restitution. Finally, the scheme proposed remains valid within the framework of MPEG-4 decoding.

The method proposed uses an object approach with two distinct phases. Firstly, the sequence background is isolated and the block effects in it are suppressed. The objects are slowly isolated from the background, benefitting from a more precise representation at each stage. Each object is then treated independently, according to its own characteristics, and then finally projected on the estimated background image to reconstruct the sequence.

### BRIEF DESCRIPTION OF THE DRAWINGS

FIG. 1 is a flow chart of the method of the invention.

### DETAILED DESCRIPTION OF THE INVENTION

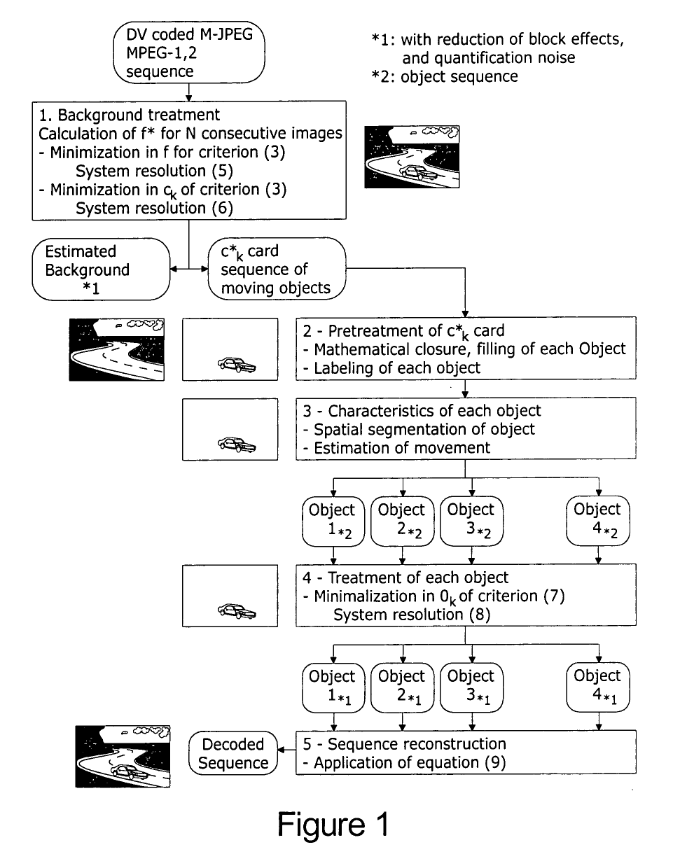

FIG. 1 represents the stages of this process.

A first stage (1) consists of estimation and background image treatment, in addition to identification of the mobile elements. A map of these mobile elements is transmitted by the treatment of these elements.

Stage (2) consists of pretreating this map by labeling and completing each element.

Stage (3) consists of spatial segmentation of the different elements permitting identification of the different mobile objects. This stage also permits estimation of this movement, and follow-up of objects during the sequence.

Stage (4) specifically treats each object identified according to the methods explained below.

Stage (5) consists of the reconstruction of the sequence which permits obtaining the decoded sequence.

Estimation of the background is considered to be an inverse problem. Let pₖ be N images of the MPEG or M-JPEG sequence containing the block effects. The background is simultaneously estimated, and the sequence of mobile objects, termed cₖ.

We want cₖ=0 if the point belongs to a mobile object, otherwise cₖ=1. We look for

f*=argmin(J_{λ})

with as criterion

J_{λ}(f, c₁, . . . , c_{N})=J₁(f, c₁, . . . , c_{N})+λ²J₂(f)+γ²J₃(cₖ)

with

$${J}_{1} ( f , {c}_{1} , … , {c}_{N} ) = {\sum }_{k = 1}^{N} {\int }_{Ω}^{} {{c}_{k}^{2} ( f - {p}_{k} )}^{2} + {α}_{c} {\sum }_{k = 1}^{N} {\int }_{Ω}^{} {( {c}_{k} - 1 )}^{2}$$

which causes spatiotemporal segmentation using N consecutive images of the sequence, and

$$\begin{matrix}{J}_{2} ( f ) = {\int }_{Ω}^{} {φ}_{1} ( ‖ ∇ f ‖ ) ) & ( 1 ) \\ {J}_{3} ( {c}_{k} ) = {\int }_{Ω}^{} {φ}_{2} ( ‖ ∇ {c}_{k} ‖ ) ) & ( 2 )\end{matrix}$$

the regularization terms which a priori contain the solution. φ₁ and φ₂ are potential functions which maintain the discontinuities in the image. Parameter α_{c} determines the importance granted to the background: the smaller α_{c} is, the more mobile objects are detected.

Relative to J₁(f), if pₖ is far away from the current estimate f, cₖ must be small: the object is moving.

This comprises a traditional approach for spatiotemporal segmentation of sequences. However, this method does not affect the block effects resulting from the DCT, and does not take into consideration coder characteristics. The treatment specific to the invention solves this problem.

To take account of the quantifier and simultaneously suppress the block effects during extraction of f background, the new criterion is minimized:

J(f, c₁, . . . , c_{N})=J₁(f, c₁, . . . , c_{N})+λ₁²J₂(f)+γ₁²J₃(f)+η₁²J₃(f)+μ₁²J₃(f) (3)

with

$${J}_{4} ( f ) = {\int }_{Ω}^{} Ψ ( \frac{\vert Rf \vert}{δ} ) \qquad ( 4 )$$

where R is the transformation into wavelets, Ψ a potential function, and δ a threshold dependent upon block effect amplitude. The value of c₁ specifies which wavelet coefficients are to be thresholded. A soft thresholding in the spatio-frequential wavelet area is then performed.

Specific knowledge of the quantification matrix used during coding permits each pixel from the reconstructed sequence to be restricted to an interval corresponding to the quantification interval.

Quantification is a discretization operation which transforms a continuous group of sample values to a discrete group. It can be performed on a single sample at the same time (scalar quantification) or several samples assembled in blocks (vector quantification). The restriction corresponding to this projection is:

$$\begin{matrix}{J}_{5} ( f ) = \frac{1}{4} {\int }_{Ω}^{} {( \vert Df - {p}_{k} + \frac{q}{2} \vert - Df + {p}_{k} - \frac{q}{2} )}^{2} + \\ \frac{1}{4} {\int }_{Ω}^{} {( \vert Df - {p}_{k} - \frac{q}{2} \vert - Df + {p}_{k} - \frac{q}{2} )}^{2}\end{matrix}$$

with D being the DCT operator, pₖ the quantified DCT coefficient, q the quantification step for the pixel considered.

The f* optimal solution for this minimization problem is found for

$$\frac{\partial {J}_{λ 1}}{\partial f} = 0 ,$$

equivalent to:

$$\begin{matrix}{\sum }_{k = 1}^{N} {c}_{k}^{2} ( f - {p}_{k} ) - {λ}_{1}^{2} div ( \frac{{φ}_{1}^{′} ( \vert ∇ f \vert )}{\vert ∇ f \vert} ∇ f ) + {η}_{1}^{2} {R}^{T} \frac{{Ψ}^{′} ( \frac{\vert Rf \vert}{δ} )}{( \frac{\vert Rf \vert}{δ} )} Rf + {μ}_{1}^{2} {D}^{T} κ ( f ) \\ = 0 \\ with \\ κ ( f ) = \{ \begin{matrix}Df - {p}_{k} + \frac{q}{2} & if & Df < {p}_{k} - \frac{q}{2} \\ Df - {p}_{k} - \frac{q}{2} & if & Df > {p}_{k} + \frac{q}{2} \\ 0 & if & Df ∈ [ {p}_{k} - \frac{q}{2} ; {p}_{k} + \frac{q}{2} ]\end{matrix}\end{matrix} \qquad ( 5 )$$

Optimal cₖ objective cards are obtained for

$$\frac{\partial {J}_{{λ}_{1}}}{\partial {c}_{k}} = 0 ,$$

yielding the following equation:

$${\sum }_{k = 1}^{N} {{c}_{k} ( f - {p}_{k} )}^{2} + {α}_{c} {\sum }_{k = 1}^{N} ( {c}_{k} - 1 ) - {γ}_{1}^{2} div ( \frac{{φ}_{1}^{′} ( \vert ∇ {c}_{k} \vert )}{\vert ∇ {c}_{k} \vert} ∇ {c}_{k} ) = 0 \qquad ( 6 )$$

The problem is solved with two successive optimizations:

Minimization of (5) in f, for cₖ given, →f*

Minimization of (6) in cₖ, for f* given →cₖ*

These two optimizations are then iterated by searching for a new f* background, followed by new cₖ, until the convergence of the solution.

The criterion is resolved using a semi-quadratic resolution algorithm described in the article Deterministic Edge-Preserving Regularization in Computed Imaging, 5(12) IEEE Transaction on Image Processing (February 1997), based on alternating minimizations. Other methods may also be used.

This new criterion therefore suppresses the background block effects, and simultaneously segments moving objects.

This criterion provides a sequence of moving card elements. In order to be able to treat each element separately, they must be spatially isolated from one another. However, the more numerous the block effects are in the original sequence, the more the cₖ cards present false or poor quality information. For example, a DCT block whose intensity changes from one image to the next may be thought of as a moving object. Several pretreatments are therefore necessary before isolating each element:

Thresholding of the cₖ card. The values with intensity less than a given threshold are brought to 0, and the others to 1.

Mathematical closure and filling of each object. Mathematical closure occurs, in other words dilatation followed by erosion, by a structuring element of size n×n, preferably with n=3. The element is filled using a traditional image path method. Other methods can also be used, such as active geodesic contours.

Mathematical opening and suppression of certain objects. The opening consists of making an erosion followed by a dilatation, to suppress the false elements coming from the DCT blocks. Other methods can also be used.

From these cₖ it is possible to label each element, isolate them from one another and consider them as objects. Henceforth, each treatment described will be completed independently on each object.

For each object in the sequence, certain characteristics will be determined which will permit a detailed and adapted treatment:

Evolution of the shape, average height and size, position, barycenter, in the sequence.

Object spatial segmentation information. A given object is spatially segmented to determine the different zones it contains (discontinuities, homogeneous zones . . . ). Traditional methods for spatial segmentation of fixed images can be used.

Estimation of object movement using traditional “block-matching” methods, or optical flow. This estimation of movement provides a movement vector d=(dxᵢ, dyᵢ) for each object, and for each image i of the sequence.

Once each object has been isolated, and its movement determined, its treatment can be customized to suppress the block effects it contains. This phase may be performed in parallel on each object, to optimize speed of execution.

For each object, we look for:

Oₖ*=argmin(J_{λ2})

with

J_{λ}(Oₖ)=J₁(Oₖ)+λ₂²J₂(Oₖ)+η₂²J₃(Oₖ)+μ₁²J₄(Oₖ) (7)

where

$${J}_{1} ( {O}_{k} ) = {\sum }_{i = n}^{n} {\int }_{Ω}^{} {( {c}_{k} - 1 )}^{2} {( {O}_{k} - {p}_{k + i} ( x + ⅆ {x}_{k + i} , y + ⅆ {y}_{k + i} ) )}^{2}$$

is a temporal averaging of the object, with compensation for movement. The value of n depends upon the object characteristics, in particular its non-stationary nature. The more rapidly the object evolves over time, the smaller the n chosen will be.

$${J}_{2} ( {O}_{k} ) = {{\int }_{Ω}^{}}^{} {( {c}_{k} - 1 )}^{2} {φ}_{3} ( ‖ ∇ {O}_{k} ‖ ) )$$

regularizes the object. λ₂ is adaptive; it n depends upon the spatial segmentation chosen to determine the different object zones, and permits customizing the object treatment.

$${J}_{3} ( {O}_{k} ) = {\int }_{Ω}^{} {( {c}_{k} - 1 )}^{2} Ψ ( \frac{\vert {RO}_{k} \vert}{δ} )$$

suppresses the block effects on the object.

$${J}_{4} ( {O}_{k} ) = \frac{1}{4} {\int }_{Ω}^{} {( {c}_{k} - 1 )}^{2} {( \vert {DO}_{k} - {p}_{k} + \frac{q}{2} \vert - {DO}_{k} + {p}_{k} - \frac{q}{2} )}^{2} + \frac{1}{4} {\int }_{Ω}^{} {( {c}_{k} - 1 )}^{2} {( \vert {DO}_{k} - {p}_{k} - \frac{q}{2} \vert - {DO}_{k} + {p}_{k} - \frac{q}{2} )}^{2}$$

permits restricting each pixel of each object to the quantification interval, to reduce quantification noise on the object.

An optimal solution Oₖ* is obtained for

$$\frac{\partial {J}_{λ 2}}{\partial {O}_{k}} = 0 ,$$

equivalent to:

(cₖ−1)²

$$\begin{matrix}\begin{matrix}( {\sum }_{i = - n}^{n} ( {O}_{k} - {p}_{k + i} ) - {λ}_{2}^{2} div ( \frac{{φ}_{3}^{′} ( \vert ∇ {O}_{k} \vert )}{\vert ∇ {O}_{k} \vert} ∇ {O}_{k} ) + \\ {η}_{2}^{2} {R}^{T} \frac{{Ψ}^{′} ( \frac{\vert {RO}_{k} \vert}{δ} )}{\frac{\vert Rf \vert}{δ}} {RO}_{k} + {μ}_{2}^{2} {D}^{T} κ ( {O}_{k} ) ) = 0\end{matrix} \\ with \\ κ ( f ) = \{ \begin{matrix}{DO}_{k} - {p}_{k} + \frac{q}{2} & if & {DO}_{k} < {p}_{k} - \frac{q}{2} \\ {DO}_{k} - {p}_{k} - \frac{q}{2} & if & {DO}_{k} > {p}_{k} + \frac{q}{2} \\ 0 & if & {DO}_{k} ∈ [ {p}_{k} - \frac{q}{2} ; {p}_{k} + \frac{q}{2} ]\end{matrix}\end{matrix} \qquad ( 8 )$$

The method of resolution used to solve the equation (8) is identical to that used above.

The method presented may be simplified, in order to reduce its complexity, and therefore calculation time.

Simplification during estimation of background and cₖ.

A first simplification consists of setting η₁=0 in the equation (3). The wavelet coefficient thresholding can in this case be used as a pretreatment for each image entering the sequence. μ₁=0 is also posited in (3), and the interval restriction can be implemented by projection on the quantification intervals. The result of this simplification is a significant decrease in calculation time, at the cost of a slight decrease in quality.

The second simplification consists of suppressing regularization on the cₖ, or positing γ₁=0 in (3). To obtain the cₖ sequence,

$$\frac{\partial {J}_{{λ}_{1}}}{\partial {c}_{k}} {\vert}_{{γ}_{1} = 0} = 0$$

is solved (cf. equation (6)). An explicit formula

$${c}_{k}^{*} = \frac{{α}_{c}}{{α}_{c} + {( f - {p}_{k} )}^{2}}$$

is then obtained which permits calculation of the sequence of moving objects.

Equation (7) can be simplified:

by positing λ₂² in (7), object regularization is suppressed. In this case, only temporal averaging of the object occurs, with compensation for movement.

by positing η₂=0 in the equation (7) and performing thresholding as a pretreatment of each object.

by positing μ₂=0 in (7), and performing projection on the qualification intervals of each object.

By totaling some of these simplifications, the algorithm becomes quick, and may be adapted to real time applications.

The decoded sequence \tilde{p} is reconstituted by using a background image over a duration of N images, and projecting into it the M objects:

\tilde{p}ₖ=cₖ*²f*+(cₖ*−1)²Oₖ* (9)

If, for a given pixel, you are on an object, cₖ*=0, the Oₖ pixel is then projected, otherwise cₖ*=1 and the pixel is projected from background f*.

The details of one or more embodiments of the invention are set forth in the accompanying description above. Although any methods and materials similar or equivalent to those described herein can be used in the practice or testing of the present invention, the preferred methods and materials are now described. Other features, objects, and advantages of the invention will be apparent from the description and from the claims. In the specification and the appended claims, the singular forms include plural referents unless the context clearly dictates otherwise. Unless defined otherwise, all technical and scientific terms used herein have the same meaning as commonly understood by one of ordinary skill in the art to which this invention belongs. All patents and publications cited in this specification are incorporated by reference.

The foregoing description has been presented only for the purposes of illustration and is not intended to limit the invention to the precise form disclosed, but by the claims appended hereto.

We claim:

1. A process for the decompression of animated images compressed by a method incorporating block treatment of images and containing
(a) a digital data recomposition phase defining predefined forms;
(b) a movement modeling stage of these forms using a process of prediction, interpolation and temporal compensation;
(c) an image composition phase from reconstructed elements of JPEG or MPEG type motion, wherein the form recomposition stage includes a process for separating fixed forms from mobile forms;
(d) a process for recording digital data corresponding to fixed forms treated with a filter which is not separable from the processes implemented in the recomposition phase in a first specific memory unit; and
(e) digital data corresponding to mobile forms in a second specific memory unit.

2. The process of claim 1, wherein the recomposition includes an irreducible digital filter.

3. The process of claim 1, wherein the filter regularizes the background image.

4. The process of claim 1,
(a) wherein the quantification interval used during background image compression is stored; and
(b) wherein the quantification interval is projected on the quantification interval.

5. The process of claim 1, wherein the reconstruction of elements uses previously defined quantification parameters for the compression of images by the coder.

6. The process of claim 5, wherein the quantification parameters are defined by the transfer function of methods for acquisition and memory storage of animated images.

7. The process of claim 1, wherein a second digital filter separates and identifies the mobile elements in mobile objects moving in a sequence.

8. The process of claim 7, wherein the identification of mobile objects is performed in accordance with the evolution of predetermined digital criteria.

9. The process of claim 8, wherein the digital criteria define the geometry of mobile objects.

10. The process of claim 8, wherein the digital criteria define the movement of mobile objects.

11. The process of claim 8, wherein the digital criteria define the spatial segmentation of mobile objects.

12. The process of claim 7, wherein temporal averaging is performed with compensation for movement for each object identified.

13. The process of claim 7, wherein the identified objects are regularized.

14. The process of claim 7, wherein the quantification interval, having served to compress the animated sequence, is stored and by the fact that it is projected on the quantification interval.

15. The process of claim 7, wherein the specific parameters for each object identified are stored separately in order to treat each object differently.

16. The process of claim 1, wherein the mobile objects and the average representation are superimposed in fixed image time for display of the animated sequence.

17. A device for decompression of animated images compressed by a method including
(a) block treatment of images containing a digital data recomposition stage defining predefined forms;
(b) a phase modeling the movement of these forms using a process of prediction, interpolation and temporal compensation;
(c) an image composition phase from reconstructed elements of JPEG or MPEG type motion, wherein the phase includes a process for separating fixed forms from mobile forms;
(d) a process for recording digital data corresponding to the fixed forms treated by a filter not separable from the processes implemented in the recomposition phase in a first specific memory unit; and
(e) digital data corresponding to mobile forms in a second specific memory unit.

18. The device of claim 16, wherein the recomposition includes methods for irreducible digital filtration.

19. The device of claim 16, wherein the device comprises methods for storage of the type of image compressed.

20. The device of claim 16, wherein the device comprises a detachable support.

21. The device of claim 19, wherein the device comprises an independent chip.

22. The device of claim 19, wherein the device comprises a graphics memory card which can be inserted into a computer.

23. The device of claim 16, wherein the device comprises a software module independent of the software present in a calculator memory.

24. A computer containing the device of claim 16.
